(19) United States
(12) Patent Application Publication
(10) Pub. No.: US 2023/0153448 A1
(43) Pub. Date: May 18, 2023

(54) FACILITATING GENERATION OF REPRESENTATIVE DATA

(71) Applicant: ADOBE INC., SAN JOSE, CA (US)

(72) Inventors: Subrata Mitra, Karnataka (IN); Sunny Dhamnani, Karnataka (IN); Piyush Bagad, Karnataka (IN); Raunak Gautam, Rajasthan (IN); Haresh Khanna, Punjab (IN); Atanu R. Sinha, Bangalore (IN)

(21) Appl. No.: 17/525,744

(22) Filed: Nov. 12, 2021

(51) Int. Cl. G06F 21/62; G06K 9/62; G06N 3/04

(52) U.S. Cl. CPC G06F 21/62; G06K 9/6256; G06N 3/0454

(57) ABSTRACT

Methods and systems are provided for facilitating generation of representative datasets. In embodiments, an original dataset for which a data representation is to be generated is obtained. A data generation model is trained to generate a representative dataset that represents the original dataset. The data generation model is trained based on the original dataset, a set of privacy settings indicating privacy of data associated with the original dataset, and a set of value settings indicating value of data associated with the original dataset. A representative dataset that represents the original dataset is generated via the trained data generation model. The generated representative dataset maintains a set of desired statistical properties of the original dataset, maintains an extent of data privacy of the set of original data, and maintains an extent of data value of the set of original data.

### BACKGROUND

Data sharing is generally intended or desired to be performed in a manner that maintains privacy, particularly for certain types of information. In an effort to secure data, some conventional technologies delete, remove, or otherwise anonymize data, such as data that may be associated with a high risk of re-identification (e.g., names, social security numbers, etc.) Although extensive anonymization of data may ensure such desired data privacy, the data can oftentimes reduce or lose the value desired by the data recipient. In this way, adding noise to individual features to anonymize the data can lose the dependence structure of the data, which can degrade the usefulness for business goals for the data recipient.

### SUMMARY

Embodiments described herein are directed to facilitating generation of representative data that maintains data privacy and data utility. That is, a data representation is generated to represent an original dataset in a way that attains desired data privacy (e.g., as indicated via privacy preferences) and desired value or usefulness (e.g., as indicated via value preferences). To this end, a dependence structure is preserved to a sufficient extent to enable common data analysis tasks (e.g., machine learning tasks) to generate results similar as to what would be obtained using original data, but also not preserved so much that privacy may be compromised via strong associations with other known individual attributes. The data privacy and data value balance can, in some cases, be calibrated or adjusted based on the desires of the data provider and/or data recipient. For example, a data provider may indicate or specify a level of data privacy desired, and the data recipient may indicate or specify a level of data value desired. As described herein, such generation of representative data that balances privacy and utility is performed in an automated and scalable manner.

### BRIEF DESCRIPTION OF THE DRAWINGS

FIG. 1 depicts a diagram of an environment in which one or more embodiments of the present disclosure can be practiced.

FIG. 2 depicts an illustrative representative data generation system, in accordance with various embodiments of the present disclosure.

FIG. 3 depicts aspects of an example graphical user interface for inputting privacy settings and value settings, in accordance with various embodiments of the present disclosure.

FIGS. 4A-4D illustrate examples graphs indicating proximities of representative data relative to an original data point, in accordance with embodiments of the present disclosure.

FIG. 5 illustrates an example original dataset and an example data representation, in accordance with embodiments of the present technology.

FIG. 6 illustrates an example distribution of an original dataset and a data representation, in accordance with embodiments of the present technology.

FIG. 7 illustrates an example process flow for facilitating representative data generation, in accordance with embodiments of the present technology.

FIG. 8 illustrates an example method for facilitating representative data generation, in accordance with embodiments of the present technology.

FIG. 9 illustrates another example method for facilitating representative data generation, in accordance with embodiments of the present technology.

FIG. 10 is a block diagram of an example computing device in which embodiments of the present disclosure may be employed.

### DETAILED DESCRIPTION

Data is oftentimes shared, for example, among or within organizations. For instance, data may be shared to enable a data recipient to construct a more complete profile of a customer, to provision more effective personalization, to make offers that are complementary to offers made by business partners, etc. Such data sharing is generally intended or desired to be performed in a manner that maintains privacy, particularly for certain types of information, such as data that may, in combination, be associated with a high risk of re-identification (e.g., age, zipcode, and profession), which are sometimes referred to as quasi-identifiers. For example, data is often desired to be shared in a secure manner such that the data cannot be used by the data recipient to reveal an individual's identity in a manner that makes a business liable or to reveal valuable information about the data-owner's business strategy.

In an effort to secure data, some conventional technologies delete, remove, or otherwise anonymize data, such as quasi-identifiers. Although extensive anonymization of data may ensure such desired data privacy, the data can oftentimes reduce or lose the value desired by the data recipient. In this way, adding noise to individual features to anonymize the data can lose the dependence structure of the data, which can degrade the usefulness for business goals for the data recipient. For instance, anonymized data may not perform well on tasks intended to be performed by a data recipient, such as classification and/or clustering, as the usefulness of the data is based on the dependencies that exist among features (e.g., knowing users of certain geographical regions tends to use certain browser type helps in defining segments by geographical region and browser types). Such poor task performance (e.g., on classification, clustering, etc.) can reduce the utility of the received data. As such, conventional techniques employing privacy preservation via anonymization or differential privacy oftentimes fail to preserve the inherent dependence structure between the different features and, as a result, do not maintain the value for the intended modeling (e.g., machine learning modeling) tasks in which the data is used.

Further, such conventional techniques may fail to prevent the leakage of information that may occur through conveyance of a combination of features. For example, various auxiliary information can be mapped to one another or to existing features to reveal sensitive information present in the original data, thereby resulting in identification of an individual's identity or other private information. To this end, simply deleting, removing, or otherwise anonymizing personally identifiable information may not secure privacy of the data.

Accordingly, embodiments described herein are directed to facilitating generation of representative data that maintains data privacy and data utility. That is, a data representation is generated to represent an original dataset in a way that attains desired data privacy (e.g., as indicated via privacy preferences) and desired value or usefulness (e.g., as indicated via value preferences). To this end, a dependence structure is preserved to a sufficient extent to enable common data analysis tasks (e.g., machine learning tasks) to generate results similar as to what would be obtained using original data, but also not preserved so much that privacy may be compromised via strong associations with other known individual attributes. Stated differently, data representations are generated in a way so as to avoid generating privacy sensitive associations between features while preserving other associations among features as well as to modify the original data in a way so that the loss of value from the generated representation on the intended task is minimized. The data privacy and data value balance can, in some cases, be calibrated or adjusted based on the desires of the data provider and/or data recipient. For example, a data provider may indicate or specify a level of data privacy desired, and the data recipient may indicate or specify a level of data value desired. As described herein, such generation of representative data that balances privacy and utility is performed in an automated and scalable manner.

The generated data representation (as opposed to original data) can be shared to a data recipient, which can then utilize the representative data to perform a data analysis task (e.g., machine learning modeling, such as clustering or classification) without comprising the value of the data and without enabling identification of individuals associated with the data. In this way, embodiments described herein overcome opposing challenges related to attaining data privacy, which requires suppression of data on some features, and data value, which is enhanced with data on more features to achieve business goals for insights.

In operation, to generate a data representation that attains data privacy and data value, a data generation model (e.g., a machine learning system or framework) may be used that considers, factors, and/or balances data privacy and data value. In some embodiments, a generative model, such as a generative adversarial network (GAN) is used to perform data representation generation. Various implementation details related to GANs may be found in “Generative Adversarial Nets” by Ian Goodfellow, et. al., published in 2014 in Advances in Neural Information Processing Systems 27, the contents of which are herein incorporated in their entirety. In addition to providing an original dataset as input to a data generation model, privacy settings and/or value settings may also be provided as input. Such privacy settings may be selected, for example, by a data provider operating at a data-provider managing device, and value settings may be selected, for example, by a data recipient operating at a data-value managing device. In embodiments in which a GAN is used, a generator of the GAN is configured to attempt to replicate the distribution of the original dataset by producing generated data points. A discriminator of the GAN generally differentiates original data against the generated representative data. In addition, and as described herein, the adversarial process between the generator and discriminator takes into account the data privacy and data value preferences. For instance, the generator may be rewarded when it performs well on features that are important for data value and may be penalized when privacy settings are violated. Accordingly, the generator is effectively task-informed to improve the performance of the generated data without comprising data privacy.

Having briefly described an overview of aspects of the present technology, various terms used throughout this description are provided. Although more details regarding various terms are provided throughout this description, general descriptions of some terms are included below to provide a clearer understanding of the ideas disclosed herein.

A data generation model generally refers to a model used to generate data (e.g., representative data). In embodiments, a data generation model is or includes a generative model, such as a generative adversarial network (GAN).

Privacy settings generally refer to any data or information associated with the privacy of an original dataset. Privacy settings may include an indication of sensitive features, or features that the data owner do not want to provide or share.

Value settings generally refer to any data or information associated with the value or importance of an original dataset (e.g., for a downstream data analysis task).

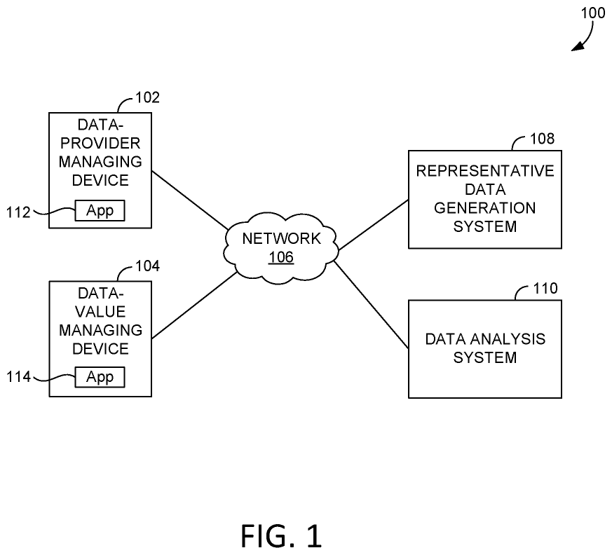

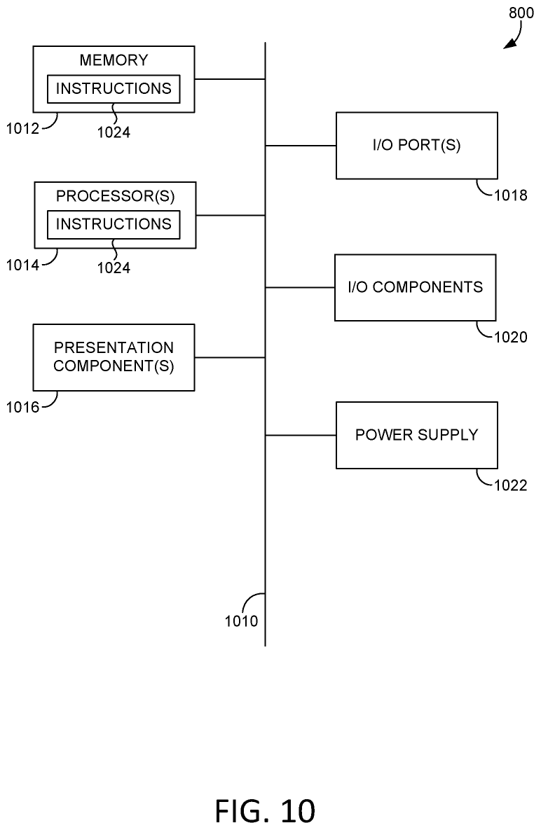

Turning to FIG. 1, FIG. 1 is a diagram of an environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 10.

It should be understood that operating environment 100 shown in FIG. 1 is an example of one suitable operating environment. Among other components not shown, operating environment 100 includes a data-provider managing device 102, a data-value managing device 104, a network 106, a representative data generation system 108, and a data analysis system 110. Each of the components shown in FIG. 1 may be implemented via any type of computing device, such as one or more of computing device 1000 described in connection to FIG. 10, for example. These components may communicate with each other via network 106, which may be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 106 is not described in significant detail.

It should be understood that any number of devices, servers, and other components may be employed within operating environment 100 within the scope of the present disclosure. Each may comprise a single device or multiple devices cooperating in a distributed environment.

Data-provider managing device 102 can be any type of computing device capable of being operated by an entity associated with providing or sharing data (a data sharing entity). A data sharing entity includes an entity (e.g., an individual associated with an organization) that provides or shares data with a data recipient. A data sharing entity may be a person or a virtual simulator. In some implementations, data-provider managing device 102 is the type of computing device described in relation to FIG. 10. By way of example and not limitation, a data-provider managing device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The data-provider managing device 102 can include one or more processors, and one or more computer-readable media. The computer-readable media may include computer-readable instructions executable by the one or more processors. The instructions may be embodied by one or more applications, such as application 112 shown in FIG. 1. Application 112 is referred to as a single application for simplicity, but its functionality can be embodied by one or more applications in practice.

The application(s) may generally be any application capable of facilitating the exchange of information between the data-provider managing device 102 and the representative data generation system 108 and/or data analysis system 110 in carrying out representative data generation. In some implementations, the application(s) comprises a web application, which can run in a web browser, and could be hosted at least partially on the server-side of environment 100. In addition, or instead, the application(s) can comprise a dedicated application, such as an application being supported by the data-provider managing device 102 and the representative data generation system 108 and/or data analysis system 110. In some cases, the application is integrated into the operating system (e.g., as a service). It is therefore contemplated herein that “application” be interpreted broadly.

In accordance with embodiments herein, the application 112 can facilitate generation of representative data. For example, data-provider managing device 102 may provide an original set of data for which representative data can be generated. An original dataset can be of any format and size. As one example, an original dataset may include a set of data in the form of rows and columns. For instance, each row may represent an individual or person, and each column may represent a different feature or aspect related to the individual or person. Although, in some embodiments, a data-provider managing device 102 may provide an original dataset, embodiments described herein are not limited hereto. For example, in some cases, an indication of an original dataset may be provided via the data-provider managing device 102 and, in such cases, the representative data generation system 108 may obtain such original data from another data source (e.g., a data store).

The data-provider managing device 102 may also provide a set of privacy settings associated with a set of original data for which representative data is to be generated. Privacy settings generally refer to any data or information associated with the privacy of an original dataset. Privacy settings may include an indication of sensitive features, or features that the data owner do not want to provide or share. Privacy settings may be provided in any number of ways.

In some cases, the privacy settings may be specific to the original dataset. That is, a data provider may select particular privacy settings based on the features or attributes of the data. Additionally or alternatively, one or more of the privacy settings may be default or global privacy settings. That is, such privacy settings may be established or designated for use in association with original datasets, irrespective of the particular original dataset. By way of example only, a data provider may have default values indicating privacy settings for data to be applied to multiple original datasets. For instance, a name or other unique identifier and particular demographics may be indicated as data that should correspond with a high security or privacy.

Data-value managing device 104 can be any type of computing device capable of being operated by an entity that manages data value. In some cases, such an entity may be associated with receiving or obtaining data (a data recipient). A data recipient includes an entity that receives or obtains data. In embodiments, the data recipient is associated with an organization that is different from an organization providing the data. In some implementations, data-value managing device 104 is the type of computing device described in relation to FIG. 10. By way of example and not limitation, a data value managing device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The data-value managing device 104 can include one or more processors, and one or more computer-readable media. The computer-readable media may include computer-readable instructions executable by the one or more processors. The instructions may be embodied by one or more applications, such as application 114 shown in FIG. 1. Application 114 is referred to as a single application for simplicity, but its functionality can be embodied by one or more applications in practice.

The application(s) may generally be any application capable of facilitating the exchange of information between the data-value managing device 104 and the representative data generation system 108 and/or data analysis system 110 in carrying out representative data generation. In some implementations, the application(s) comprises a web application, which can run in a web browser, and could be hosted at least partially on the server-side of environment 100. In addition, or instead, the application(s) can comprise a dedicated application, such as an application being supported by the data-value managing device 104 and the representative data generation system 108 and/or data analysis system 110. In some cases, the application is integrated into the operating system (e.g., as a service). It is therefore contemplated herein that “application” be interpreted broadly.

In accordance with embodiments herein, the application 114 can facilitate generation of representative data. For example, data-value managing device 104 may provide, via application 114, value settings for use in generating representative data. Value settings generally refer to any data or information associated with the value or importance of an original dataset (e.g., for a downstream data analysis task). Value settings may include an indication of important features, or features that add value to a set of data. Value settings may be provided in any number of ways.

In some cases, the value settings may be specific to the original dataset. That is, a data recipient may select particular value settings based on the features or attributes of the data. Additionally or alternatively, one or more of the value settings may be default or global value settings. That is, such value settings may be established or designated for use in association with original datasets, irrespective of the particular original dataset. By way of example only, a data recipient may have default values indicating values settings for data to be applied to multiple original datasets. For instance, a geography demographic may be indicated as data that should correspond with a high value for use in analyzing the data.

The representative data generation system 108 is generally configured to generate representative data in association with an original dataset. In this regard, the representative data generation system 108 generates synthetic data that represents at least a portion of data in an original dataset. As described herein, the representative data is desired to provide privacy or security to the data such that the data cannot be reconstructed, while maintaining value for use in accurately and effectively performing data analysis (e.g., machine learning tasks, such as clustering and/or classification) on the representative data.

At a high level, the representative data generation system 108 can obtain an original dataset, a set of privacy settings, and a set of value settings (e.g., via a data provider managing device 102 and a data value managing device 104). Based on the original dataset and applicable settings, the representative data generation system 108 can generate representative data (synthetic data) that represents at least a portion of the original dataset in accordance with the privacy settings and value settings. In this regard, the privacy settings and value settings are applied as constraints to generate representative data such that the representative data supports data privacy and also maintains value of the data.

In embodiments, the representative data generation system 108 trains a model to generate the representative data. Based on the trained data generation model, representative data is generated. For example, assume data-provider managing device 102 is operated by a data owner that desires to provide a representation of data (as opposed to the original data) to a recipient. In such a case, an original dataset, privacy settings, and value settings can be input into the model, or portion thereof, to identify or generate representative data associated with the original data. Such representative data can be provided to the data analysis system 110 for use in analyzing the data. Additionally or alternatively, the generated representative data can be provided to a device for display, such as to data-value managing device 104.

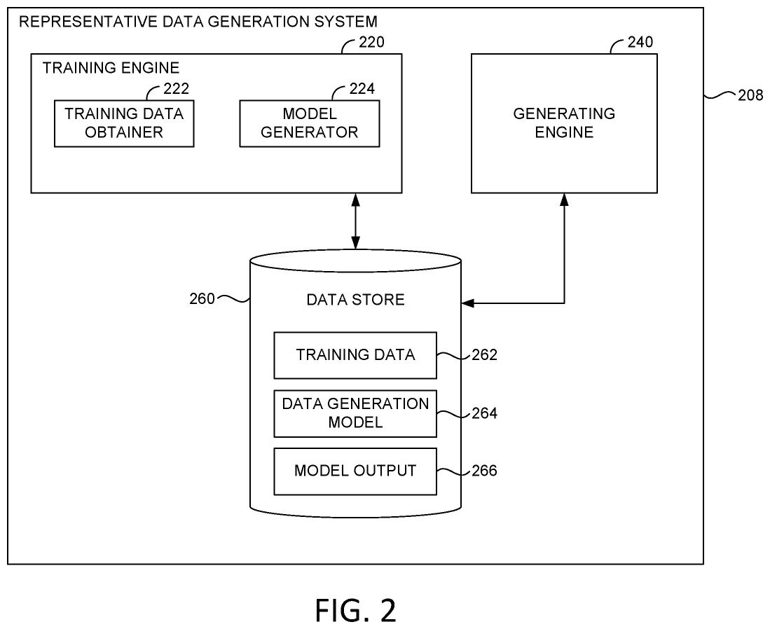

As described herein, one example of a data generation model is or includes a generative model, such as a generative adversarial network (GAN). GANs generally include a generator and a discriminator. The generator produces candidate representative data points, which are then fed to the discriminator to distinguish between the original data and the generated candidate representative data. To train the GAN in accordance with embodiments described herein, the discriminator generally reports back to the generator while accounting for privacy settings and value settings, as described in more detail with reference to FIG. 2. The trained GAN can then be used (e.g., via the generator) to produce a data representation of original data in accordance with privacy and value settings. In this way, the data representation adheres to the privacy settings specified, for example, by a data provider (e.g., data owner) and value settings specified, for example, by a data recipient, thereby resulting in a data representation that addresses privacy and security concerns as well as maintains value to a recipient of the data.

For cloud-based implementations, the instructions on representative data generation system 108 may implement one or more components of representative data generation system 108, and applications 112 and 114 may be utilized to interface with the functionality implemented on representative data generation system 108 and/or data analysis system 110. In some cases, the components, or portion thereof, of representative data generation system 108 may be implemented on a data-provider manager device, a data-value manager device, the data analysis system, or other system or device. Thus, it should be appreciated that representative data generation system 108 may be provided via multiple devices arranged in a distributed environment that collectively provide the functionality described herein. Additionally, other components not shown may also be included within the distributed environment.

The data analysis system 110 is generally configured to analyze data. In embodiments, the data analysis system 110 obtains a representative dataset that represents a set of original data. In particular, the data analysis system 110 may utilize a representative data set generated by the trained data generation model to analyze the data in any number of ways. For example, such representative data can be used (e.g., via a machine learning model) to perform classifying and/or clustering tasks.

Referring to FIG. 2, aspects of an illustrative representative data generation system are shown, in accordance with various embodiments of the present disclosure. Representative data generation system 208 includes training engine 220, generating engine 240, and data store 260. The foregoing components of representative data generation system 208 can be implemented, for example, in operating environment 100 of FIG. 1.

Data store 260 can store computer instructions (e.g., software program instructions, routines, or services), data, and/or models used in embodiments described herein. In some implementations, data store 260 stores information or data received via the various components of training engine 220 and/or generating engine 240 and provides the various components with access to that information or data, as needed. Although depicted as a single component, data store 260 may be embodied as one or more data stores. Further, the information in data store 260 may be distributed in any suitable manner across one or more data stores for storage (which may be hosted externally).

In embodiments, data stored in data store 260 includes training data 262. Training data generally refers to data used to train a data generation model, or portion thereof. As such, training data 262 can include an original dataset, a set of privacy settings, a set of value settings, and/or the like. In some cases, representative data generation system 208 can receive data from devices (e.g., received from data-provider managing device via, for example, application 112 of FIG. 1 and/or data-value managing device 104 via, for example, application 114 of FIG. 1). Additionally or alternatively, representative data generation system 208 can receive data from another component or device, such as a data store(s) (e.g., in the cloud) containing the original data or settings (e.g., default settings). Such received data may be stored in the data store 260.

Data store 260 can also be used to store data generation model 264, or a portion(s) thereof. Data store 260 may also store model output 266, which may include any output, such as a generated representative dataset. Any other data computed by or used by data generation model 264, and/or aspects associated therewith, may be stored in data store 260 or any other data store accessible to the representative data generation system 208.

Training engine 220 is generally configured to train models, such as a data generation model, including models associated therewith. Such a data generation model can be used to generate representative, or synthetic, data that represents an original data set, or portion thereof. As described herein, in embodiments, a data generation model generally generates data to represent an original dataset in accordance with privacy settings and/or value settings. Accordingly, the training engine 220 utilizes privacy settings and/or value settings along with the original dataset to generate or train a data generation model for use in generating a representative dataset.

In one embodiment, as described herein, the data generation model may be a GAN including a generator and a discriminator that, together, are used to generate a representative dataset in accordance with desired privacy and value settings. As described herein, the GAN model can utilize the original dataset, the privacy settings, and the value settings to train the model to generate a dataset representative of the original data set while taking into account the desired privacy settings and value settings. Although generally described herein as using the privacy settings and value settings for data generation model training, embodiments are not limited hereto. For example, in some implementations, either privacy settings or value settings can be used to train the model to generate a representative dataset in accordance therewith.

As depicted in FIG. 2, training engine 220 includes a training data obtainer 222 and a model generator 224. As can be appreciated, the functionality described in association therewith can be performed by any number of components. For example, the model generator 224 may include separate components of a generator and a discriminator.

The training data obtainer 222 is generally configured to obtain training data. Training data generally refers to any type of data used to train a data generation model, or models associated therewith (e.g., generator neural network and discriminator neural network). As described herein, training data may include, by way of example, an original set of data, a set of privacy settings, and a set of value settings.

An original dataset generally refers to a set of data for which representative data is to be generated. An original dataset can be of any format and size. As one example, an original data set may include a set of data in the form of rows and columns, or a matrix. For instance, each row may include data of individuals, and each column may represent a different feature or attribute related to the individual or person. In some embodiments, the attributes may be direct-identifiers, quasi-identifiers, sensitive, and others. Direct-identifiers generally refers to attributes that are associated with a high risk of re-identification. Examples include names or social security numbers. Quasi-identifying attributes can in combination be used for re-identification attacks. Examples include gender, data of birth, ZIP codes, etc. Sensitive attributes encode properties which individuals are not willing to be linked with as, if disclosed, could cause harm to the individual and, as such, may be of interest to an attacker. Examples of sensitive attributes include diagnoses, race, etc. Other attributes include attributes not associated with privacy risks.

An original dataset may be obtained in any number of ways. As one example, a data-provider managing device, such as data-provider managing device 102 of FIG. 1, may provide an original dataset. As another example, an indication of an original data set may be provided via the data-provider managing device 102 and, in such cases, the training data obtainer 222 may obtain such data from another data source (e.g., a data store).

Privacy settings generally refer to any data or information associated with the privacy of an original data set. Privacy settings may include an indication of features that the data owner does not want to provide or share. Privacy settings may be provided in any number of ways. As one example, an indication of features desired to be private or secure is provided (e.g., via a list of features). For example, a data provider may indicate a zip code feature as private as the data provider may not want the zip code to be shared to third parties. In some cases, quasi-identifier attributes are recognized or designated (e.g., automatically or by a data provider). In such a case, a data provider, such as a data owner, can specify the intensity or level of privacy desired or required for each quasi-identifier or for a combination(s) of quasi-identifiers. For instance, a user interface may provide a list or set of quasi-identifier attributes. The data provider may interact with the user interface to select or indicate which attributes to treat as private or provide a combination of attributes to treat as private. Such privacy settings may be in the form of privacy weights (e.g., [0, 1]). As previously described, in some cases, default privacy settings may be applied. In such cases, default settings may be obtained, for instance, via a data store containing the default privacy settings (e.g., associated with the data owner providing the original dataset).

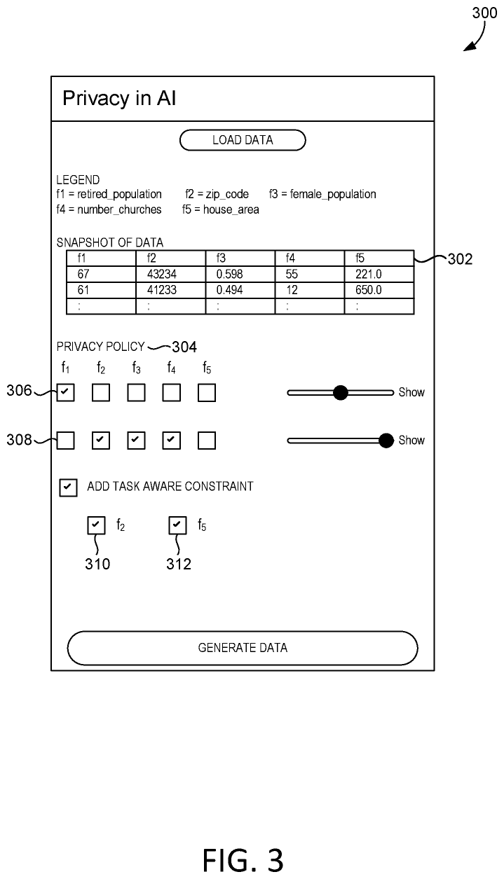

By way of example only, and with reference to FIG. 3, an example user interface 300 is provided. As shown, at least a portion of an original dataset 302 may be presented. Attributes may be presented, for example, across the top row of the original dataset 302. The attributes may also be presented in a privacy setting portion, for example, as indicated at 304. In some cases, each of the attributes may presented. In other cases, quasi-identifier attributes may be presented. A user my then select attributes for which privacy is desired. As described herein, a user may select attributes individually or as a combination. For example, the first set of attributes 306 may be used to select attributes to individual protect, and the second set of attributes 308 may be used to select a combination of attributes to protect in combination.

Value settings generally refer to any data or information associated with the value of an original dataset. Value settings may include an indication of important features, or salient features that add value to a set of data. Value settings may be provided in any number of ways. As one example, an indication of features recognized as valuable is provided (e.g., via a list of valuable features). For example, a data recipient may indicate a type of browser as valuable for performing a subsequent data analysis, or data modeling, task. By way of example only, and with reference again to FIG. 3, a value setting can be designated. For example, attributes 310 and 312 are presented as adding value. A user can select one or both of the attributes to indicate that the particular attribute adds value. In some cases, a user may select from among all attributes. In other cases, a portion of attributes may be presented and the user can select therefrom. FIG. 3 is provided for illustrative purposes and is not intended to limit the scope of the technology. For example, although the privacy and value setting selections are illustrated in a same user interface, as can be appreciated, such selections may be separated as one entity may select privacy settings while another entity may select value settings.

As previously described, in some cases, default value settings may be applied. In such a case, default settings may be obtained, for instance via a data store containing the default value settings (e.g., associated with the data recipient to receive a representative dataset). Training data may be stored or captured in a data store, such as data store 260. As can be appreciated, any number of training data can be collected and/or used to train a data generation model.

As described, the training data obtainer 222 may obtain such data in any number of ways. As one example, such data may be obtained in accordance with training a data generation model, and/or portions thereof. By way of example only, assume a data owner desires to provide data to a recipient (a consumer of the data). In such a case, the data owner, via a data-provider managing device, may select to generate a representative dataset and, based on such a selection, the training data obtainer 222 may obtain training data (e.g., via a data-provider managing device, a data-value managing device, and/or a data store). In other cases, such training data may be obtained automatically (e.g., in accordance with expiration of a time duration or on a periodic basis, etc.).

In some cases, the training data obtainer 222 analyzes or identifies particular training data for use in training a data generation model. For example, an original dataset may be obtained and analyzed to identify portions of data for use in training the model(s). Such selected data can then be used to extract features for use in training the model(s). For example, specific data, such as direct-identifier attributes, quasi-identifier attributes, sensitive attributes, and/or other attributes may be extracted or identified and used, or removed, for training a data generation model.

In some embodiments, the training data obtainer 222 may pre-process data for use in performing the training. For instance, in some cases, an original dataset, or portion thereof, may be normalized. In particular, data represented as real values and data represented as categorical attributes may be normalized. As one example, the training data obtainer 222, or other component, may normalize data represented as a real value. By way of example only, real valued attributes in a dataset may be normalized to a zero mean and unit variance. Further, in some cases, each attribute can be scaled down by compressing the attribute or performing a min-max normalizing to [0,1].

For a categorical attribute, the categorical attribute(s) in a dataset may be encoded into a real space. As one example, encoding of categorical attributes is performed using an autoencoder that learns a real-valued representation of input data (e.g., categorical attributes) to minimize the loss in reconstruction. In particular, a categorical attribute can be converted to a one-hot encoding, which includes a group of bits having a combination of values with a single high (1) bit and all other low (0) bits. In applying an autoencoder technique to obtain a dense real-valued representation of the categorical attributes, an encoder and a decoder may be used. The encoder generally produces the dense real-value representation, which is fed to the generative model to generate similar dimensional vector. Such a generated vector is passed to the decoder network of auto-encoder to obtain back the values for the categorical attribute(s). Alternatively or additionally, a Gumbel soft-max technique may be used to normalize categorical attributes. In this way, a c number of neurons are used in a last layer of generator output corresponding to the categorical variable, where c is the number of different classes for the categorical variable. Thereafter, a Gumbel soft-max layer is applied to the last layer to obtain a probability distribution over the c classes.

Other types of data can be handled in any number of ways. For example, for a date attribute, the date can be converted into a UNIX time stamp and, thereafter, used to train a data generation model.

In some embodiments, the training data obtainer 222 may also pre-process privacy and/or value settings. For example, a privacy setting provided by a data provider may be processed to be represented in the form of a weight. As another example, a value setting provided by a data recipient may be processed to extract the most important features via saliency maps. Saliency maps provide a way of measuring the impact each attribute has on the performance of the task. Weights (e.g., [0, 1]) can be assigned to important attributes in order of increasing saliency scores.

As described, privacy settings and value settings initially provided (e.g., by a data provider and/or data recipient) may be processed and/or converted to other values (e.g., weights, such as [0, 1]) for use by a data generation model, the reference to privacy settings and/or value settings can generally include the initially obtained data and/or processed data (e.g., weights) used to represent privacy and value measures.

The model generator 224 is generally configured to generate or train a data generation model. A data generation model generally refers to a model that is generated to generate data. In particular, the data generation model is trained to generate synthetic data that is representative of original data, while maintaining desired privacy settings and/or value settings. To do so, the data generation model is trained using an original dataset in association with privacy settings and/or value settings. Such privacy settings enable constraints or enforcement related to maintaining privacy of the data such that the data cannot be used to perform re-identification attacks (linking an individual to a specific data entry or attribute). On the other hand, the value settings enable constraints or enforcement related to maintaining value-add of the data, for example, for use on down-stream tasks (e.g., binary classification, cluster, other machine learning implementations, etc.).

In embodiments, various machine learning techniques may be used to train a data generation model. As one example, a data generation model is in the form of a generative model. A generative model generally refers to a model used to generate data. In particular, a generative model typically generates new data, that is, data that has not been previously recognized, and that fits into a data distribution (e.g., a pre-defined dataset distribution). Accordingly, a generative model intends to generate new data for which it is difficult to recognize the differences between the original data and the generated new data. Although a data generation model is generally described herein in the form of a generative model, other types of model may be used and the technology described herein is not limited thereto.

One type of generative model that can be used to generate representative data is a generative adversarial network (GAN). In particular, a GAN is a generative model that can be used to produce synthetic data after being trained. The GAN includes two components, which includes a generator (neural network) and a discriminator (neural network). The generator and the discriminator in a network work as adversaries, playing a zero-sum minimax game. On one hand, the generator tries to produce data points that are similar to original data points. On the other hand, the discriminator tries to maximize the loss function with an objective of successfully differentiating between real and fake points. Thus, it attempts to minimize the difference between real and fake points. Overall, GAN strives to match a generated distribution to a real, or original, data distribution. Minimizing the distance between the two distributions is critical for creating a system that generates content that appears as though it is from the original data distribution.

In some implementations, a Wasserstein GAN (WGAN) is used as a data generation model. At a high level, a WGAN uses an approximation of Wasserstien distance as an optimization objective metric, as opposed to minimizing the Jenson-Shannon divergence between the original and generated distribution. Even more specifically, WGAN-gradient penalty (WGAN-GP) may be used as a data generation model. WGAN-GP penalizes the norm of gradient of the critic with respect to its input as opposed to clipping weights. Such a WGAN-GP implementation enables stable training and can be used to achieve high-quality privacy preserving data output. In this way, the WGAN-GP model can be used as a base generative model and, as described herein, incorporate privacy settings and value settings to attain a desired representative dataset. Various implementation details related to WGAN-GP may be found in “Improved Training of Wasserstein GANs” by Ishaan Gulrajani, et. al., published in 2017 in Neural Information Processing Systems, Volume 30, the contents of which are herein incorporated in their entirety.

As described herein, a data generation model (e.g., in the form of WGAN-GP) includes a generator and a discriminator. The generator is responsible for producing or generating synthetic data. Generally, a generator takes as input some latent variable and outputs data that is of a same form as data in the original dataset. For example, the generator can be provided with randomized input that is sampled from a predefined latent space (e.g., a multivariate normal distribution), or otherwise referred to as noise. The generator learns to map from the latent space to a data distribution of interest (e.g., the original data distribution). By way of example only, assume a latent variable is z and a target variable is x. The generator strives to learn a function that maps z, the latent space, to x, the original data distribution. The objective of the generator is generally to increase the error rate of the discriminator, that is, to deceive the discriminator by producing data representation candidates that the discriminator identifies as not synthetic. In accordance with embodiments described herein, the generator is rewarded when it performs well on features that are important for value-addition and is penalized when privacy settings are violated. Accordingly, the generator is task-informed to improve performance of the generated representative data.

The discriminator analyzes the candidate data representations generated by the generator. In particular, the discriminator is generally responsible for predicting whether a given candidate data representation is real or synthetic. For example, if the discriminator identifies a data representation as real, it will output an indication thereof. Stated differently, the discriminator differentiates original data from representative data. As described, in some embodiments, a WGAN or WGAN-GP is implemented. In such cases, the discriminator can be in the form of a critic function that approximates a distance score, which may referred to as an Earth-Mover (EM) distance or Wasserstein distance. The EM distance generally calculates the minimal cost to transform one probability distribution into another. A critic function can be parameterized and trained to approximate an EM distance, or distance score, between an original data distribution and a generated distribution. Thereafter, the generator function can be optimized to reduce the EM distance. With WGAN, the weights that parametrize the critic function are clipped. Weight clipping may be used to maintain the theoretical guarantees of the critic function. With WGAN-GP, instead of using weight clipping, a penalization term is added to the norm of the gradient of the critic function.

As described, the generator and discriminator perform an adversarial process. In this regard, the generator and discriminator oppose one another to maximize opposing goals—the generator to create data that appear as though part of the original dataset and the discriminator to differentiate the generated representative data as real or synthetic. As such, GAN attempts to find an equilibrium between the generator and discriminator. In this regard, a data generation model in the form of a generative model attempts to match a generated data distribution to an original data distribution. Minimizing a distance between the distributions enables the generation or creation of representative data that is new and appears to be from the original data distribution. As such, an objective function or loss function is generally used to measure the difference between the distributions and, thereafter, the generator is trained or optimized to reduce this difference, or distance.

In this way, to train a data generation model, such as a WGAN-GP, an objective function(s), or a loss function, may be used. Stated differently, the data generation model, or portions thereof, can be trained by evaluating loss to determine any errors or discrepancies. Errors can include inaccuracies, flaws, variations, and/or divergences between the training output and the desired output, often referred to as the ground-truth or output if the model or network was perfectly trained. This desired output may be reflected as the original dataset, or a portion thereof, and used for comparison with the training output. In some embodiments, updating or training the model involves feeding errors back through the model so the algorithm can adjust parameters in order to reduce the value of the error. For example, backpropagation can be applied to the generator and/or discriminator to train a model to optimize a minimax equation such that the discriminator can no longer differentiate between real and synthetic samples because the generative data distribution is generally indistinguishable from the original data distribution.

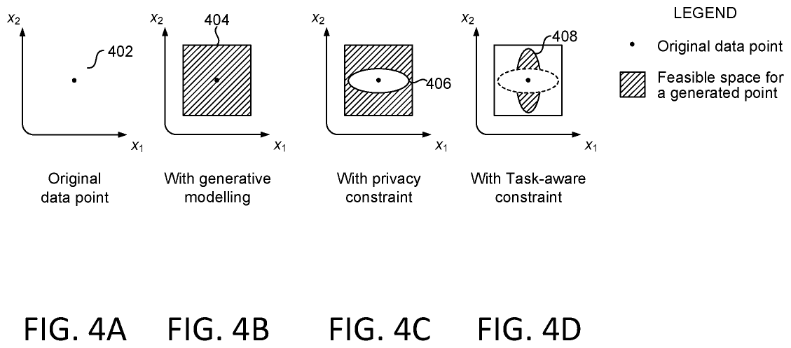

Any type of objective or loss function may be used in association with the data generation model to train the model. In embodiments, a discriminator may use an objective function to differentiate original data against generated representative data. For example, with reference to FIG. 4A and FIG. 4B, assume an original data point 402 exists, as illustrated in FIG. 4A. Further assume, a data generation model, for example via a generator generates a candidate representative data point. Using an objective function, the model would tend to generate a point(s) in proximity 404 of the original data point 402, as shown in FIG. 4B.

In an implementation of WGAN-GP, below is an example of an objective function:

$${min}_{{θ}_{ℊ}} {max}_{{θ}_{d}} \{ D ( x ) - D ( G ( z ) ) + {λ ( {‖ {∇}_{\hat{x}} ( D ( \hat{x} ) ) ‖}_{2} - 1 )}^{2}$$

In this example, the objective function includes using the WGAN value function along with a gradient penalty, in which (x) refers to an original data, G(z) refers to an generated data, and \hat{χ} refers to random samples. The WGAN objective function generally minimizes cost of transporting mass in order to transform one distribution to another. The gradient penalty generally includes a penalty on the gradient norm.

In one embodiment, an objective function that incorporates data privacy and/or data value is used. In this regard, in addition to an objective of differentiating original data points against generated representative data points, the objective function may incorporate data privacy and/or data value aspects, for example, to penalize the generator if generated representative data is too close to original data points and/or reward the generator when it performs well on value-add features. As can be appreciated, an objective function that incorporates both data privacy and data value may be used in some implementations. In other implementations one objective function that incorporates data privacy may be used as well as another objective function that incorporates data value may be used. In yet other implementations, an objective function that incorporates data privacy or data value may be used. The objective functions provided herein are only for illustrative purposes and are not intended to be limited herein.

With regard to maintaining data privacy, a data privacy regulator or constraint may be incorporated or aggregated with the objective function to result in representative data that maintains data privacy. In this way, an objective function can incorporate data privacy by penalizing the generator in cases in which it produces representative data that is too close to original data. In some cases, such a penalization may occur in cases in which the representative data is too close to original data in the space of quasi-identifier features. As described quasi-identifiers refer to data or information that are not of themselves unique identifiers but are sufficiently correlated to create a unique identifier. That is, quasi-identifiers may enable a data recipient to identify an individual associated with data. For example, neither of gender, birth dates, or postal codes uniquely identify an individual, but the combination of all three can reveal an identity of an individual with high probability. In this way, including a data privacy shield in the objective function should prevent re-identification and sensitive attribute disclosure attacks. In particular, the data privacy shield can perturb data, such as quasi-identifiers, sufficiently so that the generated representative data succeeds in distorting the effectiveness of data privacy attacks.

As an example, and with reference to FIG. 4C, assume attribute x₁ is a quasi-identifier and important for a subsequent data analysis task. As x₁ is a quasi-identifier attribute, it is perturbed by enforcing a privacy constraint, via an objective function, that penalizes the generator in cases in which the generator produces points in the non-shaded ellipse 406, as illustrated in FIG. 4C.

Generally, the privacy regulator or constraint is used to penalize the generator for producing points that are too close to original data points in the space of features that can be potentially linked to re-identify individuals or infer information about their sensitive attributes. Stated differently, a data representation D′ protects the privacy of users constituting the original dataset D and minimize disclosure threats, which can be represented as:

min P{d(r,A(D′,aux(r)))≤∈},∀r∈D

wherein, r is a record in D, aux(r) refers to auxiliary information an attacker may have about r, and A is an adversary function attempting to disclose information about individuals. In embodiments, the distance function d is considered on the quasi-identifier attribute space instead of the entire feature space.

One example of a privacy-aware objective, for example for a WGAN-GP implementation, is represented as:

$${min}_{{θ}_{ℊ}} {max}_{{θ}_{d}} \{ D ( x ) - D ( G ( z ) ) + {λ ( {‖ {∇}_{\hat{x}} ( D ( \hat{x} ) ) ‖}_{2} - 1 )}^{2} - {λ}_{p} 𝔼 ( {d}_{p} ( {p}_{o} , {p}_{ℊ} ) \}$$

In this equation, λp is a hyper-parameter used to tune the effect of privacy regulator or constraint. Such a hyper-parameter can be tuned, as needed to attain a privacy goal(s), for example by a data owner. The distance of a generated point from k nearest original points assigns the penalty. Distance dₚ refers to an exponential of weighted distance based on the obtained privacy settings, or weights.

$${d}_{p} ( G ( z ) , {p}_{o} ) = exp \{ - {\sum }_{i = 1}^{k} {‖ G ( z ) - {x}_{i} ‖}_{2}^{weighted} \}$$

With regard to maintaining data value, a data value regulator or constraint may be incorporated or aggregated with the objective function to result in representative data that maintains data value. In this way, an objective function can incorporate data value by rewarding the generator in cases in which it performs well on features that are important for adding value to subsequent data analysis. Advantageously, including a data value regulator in the objective function should maintain usefulness of the representative data.

As an example, and with reference to FIG. 4D, assume attribute x₁ is a quasi-identifier and important for a subsequent data analysis task. To improve quality of the data for downstream data analysis (e.g., training a classifier), the generator is rewarded if it produces points that are close to original points in the space of important features (e.g., as indicated via data value managing device). In FIG. 4D, for example, the generator is rewarded if the representative data falls in the shaded region 408, as illustrated in FIG. 4D.

Generally, the value regulator or constraint is used to reward the generator for producing representative data close to original data in the space of salient or important features (e.g., based on input from a data recipient). As can be appreciated, the usage of D′ as a substitute to that of D for a given task should not make a significant difference in the performance of that task (e.g., machine learning task), which can be represented as:

$$min {d}^{′} ( {ℊ}^{*} ( D ) , {ℊ}^{*} ( {D}^{′} )$$

$$where {ℊ}^{*} ( D ) := arg {min}_{ℊ} \{ {𝔼}_{( x , 𝓎 ) ∈ D} [ ℒ ( ℊ ( x ) , 𝓎 ) ] \}$$

In this equation, g*(D) refers to a model learned from data D, L refers to the loss function for optimization and d′ denotes a distance metric between models, for example, in relation to accuracy.

One example of a value-aware objective that ensures value-addition, for example for a WGAN-GP implementation, is represented as:

$${min}_{{θ}_{ℊ}} {max}_{{θ}_{d}} \{ D ( x ) - D ( G ( z ) ) + {λ ( {‖ {∇}_{\hat{x}} ( D ( \hat{x} ) ) ‖}_{2} - 1 )}^{2} - {λ}_{u} 𝔼 ( {d}_{u} ( {p}_{o} , {p}_{ℊ} ) ] \}$$

wherein λᵤ is a hyper-parameter used to tune the effect of value regulator. Such a hyper-parameter can be tuned, as needed to attain a value goal(s), for example by a data owner or data consumer. The distance of a generated data point from k nearest original data points is used to reward the generator based on weighted distance of G(z) to the k original data points. Distance dᵤ applies an opposing effect to that applied via a privacy regulator. The distance dᵤ can be represented as:

$${d}_{u} ( G ( z ) , {p}_{o} ) = 1 - exp \{ - {\sum }_{i = 1}^{k} {‖ G ( z ) - {x}_{i} ‖}_{2}^{weighted} \}$$

In this regard, the generator is rewarded in cases in which the importance-weighted distance between G(z) and original data points is less.

The objective functions presented above include a privacy constraint or a value constraint. As described herein, an objective function, however, can incorporate both a privacy constraint and a value constraint. In such a case, one example of an overall objective function that incorporates both a privacy constraint and a value constraint that can be used, for example, in a WGAN-GP implementation, is represented as:

$${min}_{{θ}_{ℊ}} {max}_{{θ}_{d}} \{ D ( x ) - D ( G ( z ) ) + {λ ( {‖ {∇}_{\hat{x}} ( D ( \hat{x} ) ) ‖}_{2} - 1 )}^{2} + {λ}_{u} 𝔼 ( {d}_{u} ( {p}_{o} , {p}_{ℊ} ) ] - {λ}_{p} 𝔼 ( {d}_{p} ( {p}_{o} , {p}_{ℊ} ) ] \}$$

Such an objective function enhanced with privacy and/or value constraints can be minimized to train a data generation model, such as a GAN (e.g., WGAN-GP model) which then generates the representation of data. When the generator and discriminator attain convergence, a data generation model can be used to produce privacy aware, valuable data representations. Such a convergence is attained when loss values for both the generator and discriminator stabilize.

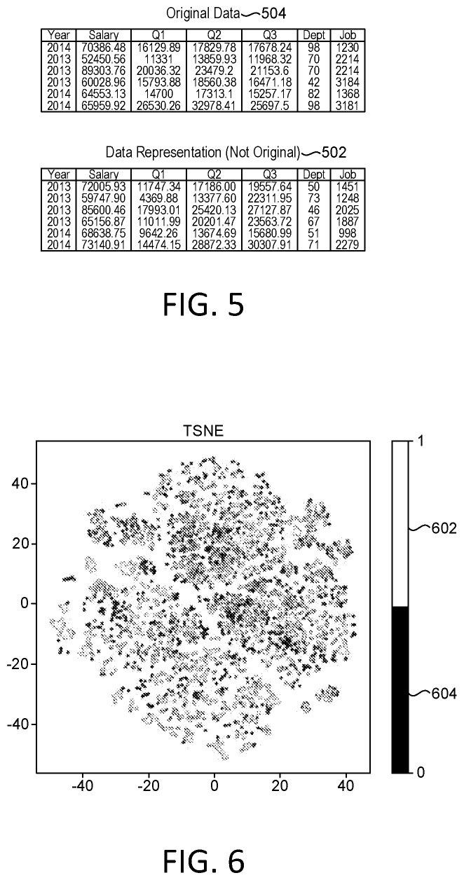

Once trained, the generator can produce a data representation that adheres to privacy and value settings. One example of a representative dataset is provided in FIG. 5. In FIG. 5, a representative dataset 402 is illustrated in association with an original dataset 504 for which the representative dataset was generated. As shown, the representative dataset 502 includes both numerical and categorical features that are the same as the original dataset 504. Advantageously, while the representative dataset 502 maintains most of the statistical properties of the original dataset 504, none of the rows in the representative dataset 502 are the same as any row from the original dataset 504, thereby providing new data that represents the original data. FIG. 6 provides one example of a distribution of generated data 602 as compared to original data points 604. As shown, the synthetically generated data and the original data overlap in distribution.

A generated representative dataset can be used in any number of ways. As described herein, the representative dataset can be provided to a data analysis system that analyzes such data. Advantageously, the representative dataset is generated in a manner that adds value for various data analysis tasks, such as machine learning tasks, particularly, clustering and classification (e.g., linear regression, random forest, and gradient boosting). In particular, the representative dataset can be used in various machine learning tasks to generate results that are close or similar to that which would be generated had the original dataset been used. Further, the representative dataset maintains data privacy such that privacy threats, such as attribute disclosures and re-identification attacks, are avoided.

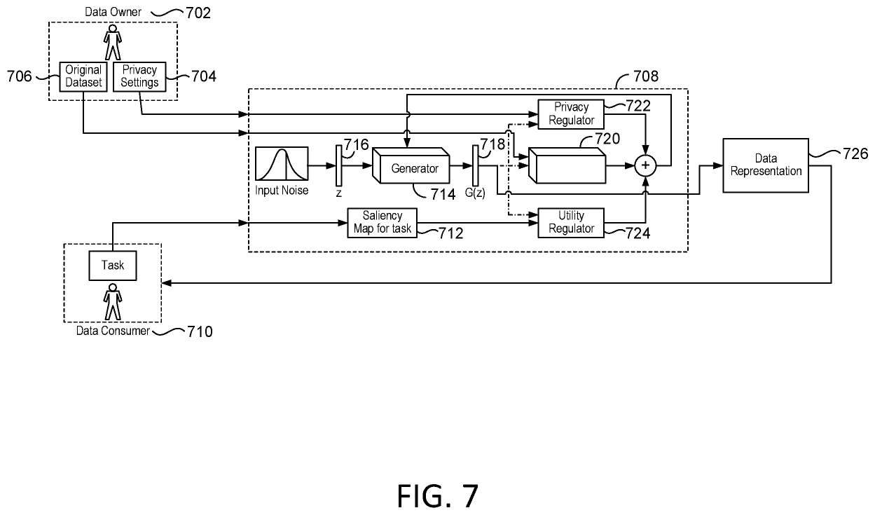

FIG. 7 provides an example process flow for generating representative data. As shown, a data owner 702 can specify a set of privacy settings 704 and an original dataset 706 to the generative model system 708. In some embodiments, the privacy settings 704 may indicate sensitive or quasi-identifiers that are desired to be maintained as private data. As one example, a privacy setting may indicate an intensity of privacy for a single quasi-identifier or a combination of quasi-identifiers. In addition to providing a set of privacy settings, a data consumer 710 desiring to perform a downstream task, such as data mining, can specify value settings 712, including features that are important for the task obtained through saliency maps. The generator 714 will take in noise z 716 as input and produce a data point G(z) 718 of the dimension x, which is sent to the discriminator 720 for evaluation and/or feedback.

Along with the general discriminator objective of maximizing the distinction between real and synthetic data points, the discriminator 720 also reports the extent to which the generated data point is in proximity of an original data point on the quasi-identifier features. Stated differently, the discriminator 720 distinguishes between original and generated data, and reports back to the generator while accounting for privacy and value settings. In this regard, the discriminator 720 can utilize privacy regulator 722 and utility regulator 724 for training. In cases in which the generated data is closer than a certain threshold, the generator 714 can be penalized through an exponential loss function. Further, the generator 714 also incorporates feedback about effectiveness of the generated data on the downstream task. As such, the generator 714 will try to produce points close to the real ones in the space of important features. Once trained, generator 714 produces a data representation 726, which adheres to privacy and value settings. The data representation 726 can then be provided to the data consumer 710, which may then use the data representation 726 to perform a task, such as classification or clustering.

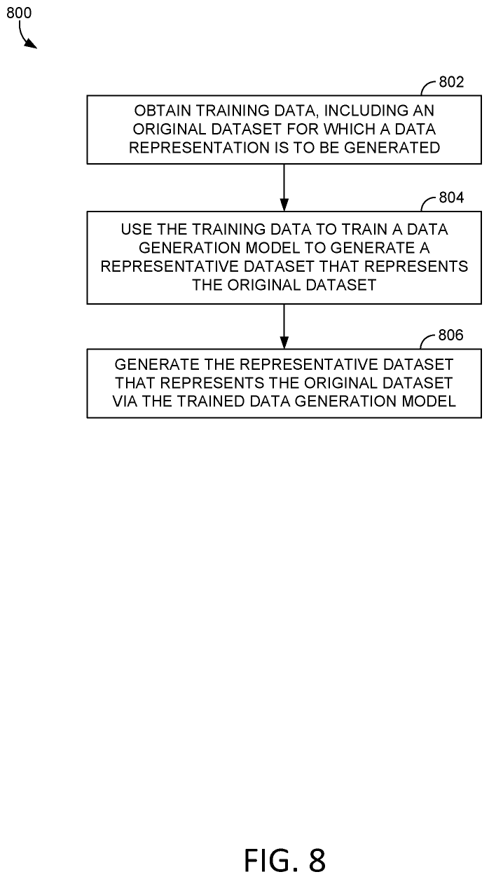

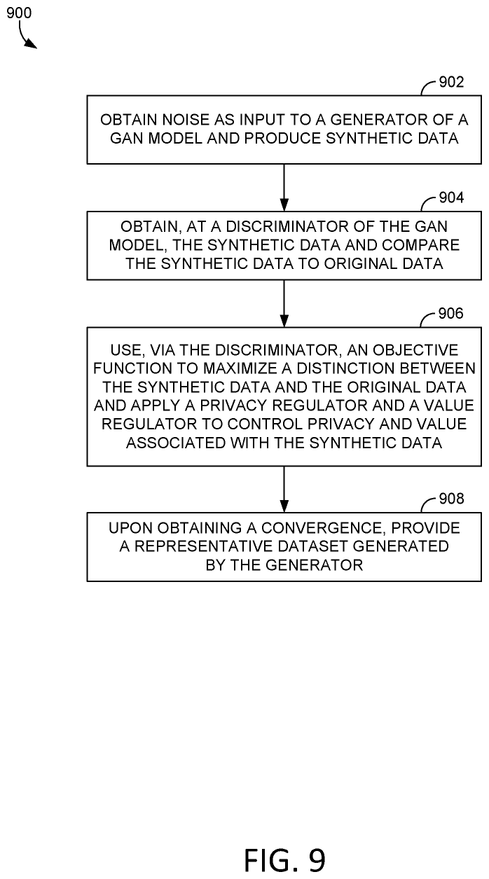

Turning now to FIGS. 8-9, FIGS. 8-9 provide illustrative flows of methods for facilitation of representative data generation. With reference initially to FIG. 8, a process flow is provided showing an embodiment of method 800 for generating representative data, in accordance with embodiments of the present technology.

At block 802, training data, including an original dataset for which a data representation is to be generated, is obtained. Training data may also include a set of privacy settings and a set of value settings. At block 804, the training data is used to train a data generation model to generate a representative dataset that represents the original dataset. In embodiments, the data generation model is trained based on the original dataset, a set of privacy settings indicating privacy of data associated with the original dataset, and a set of value settings indicating value of data associated with the original dataset. The data generation model may be a GAN model, such as a WGAN-GP model. At block 806, a representative data that represents the original dataset is generated, via the trained data generation model. In embodiments, the generated representative data is statistically similar to the original dataset. Stated differently, the generated representative data maintains a set of desired statistical properties of the original dataset. In this way, the data generation model is trained to decrease a distance metric between the two data sets that is defined over a feature or attribute space(s). The generated representative data also maintains an extent of data privacy of the set of original data and maintains an extent of data value of the set of original data.

With reference to FIG. 9, FIG. 9 provides an example 900 implementation for generating representative data. Initially, at block 902, a generator of a GAN network obtains noise as input and produces synthetic data. At block 904, a discriminator of the GAN network obtains the synthetic data and compares the synthetic data to original data. At block 906, the discriminator uses an objective function to maximize a distinction between the synthetic data and the original data and apply a privacy regulator and a value regulator to regulate or control privacy and value associated with the synthetic data. This process described in blocks 902-906 continues until a convergence is attained. When a convergence is attained, at block 908, a representative dataset generated by the generator is provided, for example, for subsequent use in training a machine learning model.

Having described embodiments of the present invention, FIG. 10 provides an example of a computing device in which embodiments of the present invention may be employed. Computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 10 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1012 includes computer storage media in the form of volatile and/or nonvolatile memory. As depicted, memory 1012 includes instructions 1024. Instructions 1024, when executed by processor(s) 1014 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. I/O components 1020 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 1000. Computing device 1000 may be equipped with depth cameras, such as stereoscopic camera systems, infrared camera systems, RGB camera systems, and combinations of these, for gesture detection and recognition. Additionally, computing device 1000 may be equipped with accelerometers or gyroscopes that enable detection of motion. The output of the accelerometers or gyroscopes may be provided to the display of computing device 1000 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A computer-implemented method for facilitating representative data generation, the method comprising:
obtaining an original dataset for which a data representation is to be generated;
training a data generation model to generate a representative dataset that represents the original dataset, wherein the data generation model is trained based on the original dataset, a set of privacy settings indicating privacy of data associated with the original dataset, and a set of value settings indicating value of data associated with the original dataset; and
generating, via the trained data generation model, the representative dataset that represents the original dataset, wherein the generated representative dataset maintains a set of desired statistical properties of the original dataset, maintains an extent of data privacy of the set of original data, and maintains an extent of data value of the set of original data.

2. The computer-implemented method of claim 1, wherein the original dataset is in the form of a matrix including rows having data associated with individuals and columns representing different features related to the individuals.

3. The computer-implemented method of claim 1, wherein the set of privacy settings including a level of privacy desired for each quasi-identifier feature in the original dataset.

4. The computer-implemented method of claim 1, wherein numerical and categorical attributes in the original dataset are normalized for use in training the data generation model.

5. The computer-implemented method of claim 1, wherein the set of value settings are represented via a saliency map indicating measures of impact various attributes associated with the original dataset have on performance of a subsequent machine learning task.

6. The computer-implemented method of claim 1, wherein the data generation model is in the form of a generative adversarial network having a generator that attempts to produce data points similar to original data points of the original dataset and a discriminator that attempts to minimize a distance between the original dataset and synthetic data.

7. The computer-implemented method of claim 1, wherein the data generation model is trained using an objective function that incorporates the set of privacy settings to penalize a generator of the data generation model if generated representative data is too close to original data of the original dataset and incorporates the set of value settings to reward the generator when it performs well on value-add features.

8. The computer-implemented method of claim 1 further comprising providing the generated representative dataset for use in performing a machine learning task.

9. The computer-implemented method of claim 1, wherein the set of privacy settings is obtained via a data provider and the set of value settings is obtained via a data recipient.

10. One or more computer-readable media having a plurality of executable instructions embodied thereon, which, when executed by one or more processors, cause the one or more processors to perform a method for facilitating representative data generation, the method comprising:
obtaining a set of original data for which a data representation is to be generated;
generating, via a trained data generation model, a set of representative data representing the set of original data, wherein the set of representative data maintains an extent of data privacy and an extent of value based on the trained data generation model being trained using a privacy constraint and a value constraint; and
providing the set of representative data for use in performing a subsequent machine learning task.

11. The media of claim 10, wherein the extent of data privacy maintained prevents a subsequent re-identification of an individual associated with the set of original data.

12. The media of claim 10, wherein the extent of value maintained enables a subsequent use of the set of representative data to perform the subsequent machine learning task with a similar outcome as to what would be achieved using the set of original data.

13. The media of claim 10, wherein the privacy constraint and the value constraint are incorporated into an objective function used to train the trained data generation model.

14. The media of claim 10, wherein the privacy constraint is used to penalize a generator when the generator produces data too close to the set of original data.

15. The media of claim 10, wherein the privacy constraint includes a hyper-parameter used to modify effect the privacy constraint, and wherein the privacy constraint is based on at least one privacy setting indicated by a provider of the set of original data.

16. The media of claim 10, wherein the value constraint is used to reward a generator for producing data close to the set of original data in relation to salient features.

17. The media of claim 10, wherein the value constraint includes a hyper-parameter used to modify effect of the value constraint.

18. A computing system comprising:
one or more processors; and
one or more non-transitory computer-readable storage media, coupled with the one or more processors, having instructions stored thereon, which, when executed by the one or more processors, cause the computing system to: this one is just training
obtain an original dataset for which a data representation is to be generated;
train a generative adversarial network (GAN) model to generate a representative dataset that represents the original dataset and maintains a level of privacy and value in the representative dataset, wherein the GAN model, including a generator and a discriminator, is trained by:
the generator generating synthetic data in a same form as the original dataset, and
the discriminator using an objective function to train the generator based on the generated synthetic data, wherein the objective function incorporates a privacy constraint to maintain privacy of the generated synthetic data and a value constraint to maintain value of the generated synthetic data.

19. The system of claim 18, wherein the privacy constraint includes a hyper-parameter used to modify effect of the privacy constraint, and wherein the privacy constraint is based on at least one privacy setting indicated by a provider of the set of original data.

20. The system of claim 18, wherein the value constraint includes a hyper-parameter used to modify effect of the value constraint, and wherein the value constraint is based on at least one value setting indicated by an intended recipient of the representative dataset.
